(19) United States
(12) Patent Application Publication
(10) Pub. No.: US 2016/0101703 A1
(43) Pub. Date: Apr. 14, 2016

(54) SYSTEMS AND METHODS FOR SAFE CHARGING FOR ELECTRIC OR HYBRID ELECTRIC VEHICLES

(71) Applicant: Efficient Drivetrains, Inc., San Jose, CA (US)

(72) Inventor: Andrew Frank, Davis, CA (US)

(21) Appl. No.: 14/514,036

(22) Filed: Oct. 14, 2014

(51) Int. Cl. B60L 11/18

(52) U.S. Cl. CPC B60L 11/1809

(57) ABSTRACT

Systems and/or methods for charging electric vehicles and plug-in hybrid electric vehicles are disclosed. In various embodiments, charging to the battery pack may dynamically be changed according to a characteristic of the external electrical source to which the vehicle is plugged. While monitoring the characteristics, the charging level may be changed up or down depending on the characteristic.

### BACKGROUND

In the field of electric vehicles (EVs), hybrid electric vehicles (HEVs) and/or plug-in hybrid electric vehicles (PHEVs) (collectively, “EVS” or “Electrical VehicleS”), it is known to plug these EVS vehicles into an electrical energy source, to charge the battery, e.g., at a time when the vehicle is not in use.

FIG. 1 is a typical arrangement 100 for the plugging in of such vehicles in use today. EVS have mechanical and electrical communication with a J1772 standard plug 112—which usually comes with delivery of the vehicle at time of purchase. Plug 112 is attached to an Electric Vehicle Supply Equipment (EVSE) box 108 via a long cord 110. EVSE 108 is, in turn, connected to a standard wall plug 102 (with or without Ground Fault Interruption (GFI)) via a short cord 104.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Some embodiments of the present application provide for charging electric vehicles and plug-in hybrid electric vehicles. In various embodiments, charging to the battery pack may dynamically be changed according to a characteristic of the external electrical source to which the vehicle is plugged. While monitoring the characteristics, the charging level may be changed up or down depending on the characteristic.

In one aspect, a system for safe charging an EVS, said EVS connecting to an external electrical power line to charge a battery pack, the system comprising: a controllable battery charger, said controllable battery charger configured to be in electrical communication with an external electrical power line; a safe charging system (SCS) module, the safe charging system module in electrical communication with the controllable battery charger, the SCS module receiving signals correlating to the electrical power from the external electrical power line and outputting control signals to the controllable battery charger; and wherein further the SCS module outputs control signals to the controllable battery charger to dynamically adjust the charging of the battery according to a function of measured external electrical power characteristics.

In one aspect, a method A method for the safe charging of an EVS, the EVS capable of electrically communicating with an external electrical power source and providing safe charging for a battery pack, the method comprising: (i) plugging in the EVS to an external electrical source; (ii) measuring a first characteristic related to the external electrical source; (iii) charging the battery pack at a first desired current level; (iv) dynamically changing the charging current level according to a metric depending upon the first characteristic; (v) charging of the battery pack for a desired time period; (vi) upon expiration of the desired time period, returning to (ii) for continue processing; and (vi) stopping the charging the battery pack according to the desired conditions.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a conventional J1772 Standard plug for charging EVs and PHEVs.

FIG. 2 shows one possible embodiment of a safe charging system for EVs and PHEVs as made according to the principles of the present application.

FIG. 3 shows another embodiment of a safe charging system.

FIG. 4 depicts one embodiment of a control method and/or module for operating a safe charging system.

FIG. 5 depicts another embodiment of a control method and/or module for operating a safe charging system.

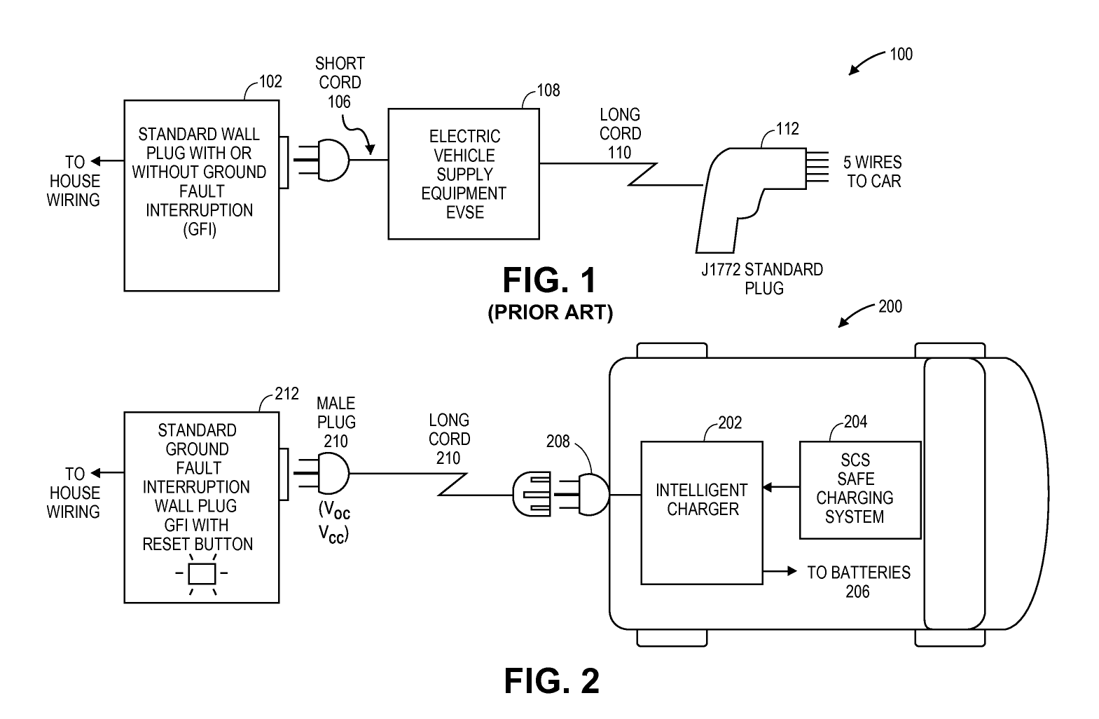

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### Introduction

An EVSE box is usually a special box that is to be plugged into an ordinary electrical outlet in a building or structure that is rated at a “standard” current and voltage with or without ground fault protection.

In many configurations, an EVSE may provide for many of the following:

(1) Ground fault interruption (GFI). This feature measures current flowing into the safety ground circuit. If it is above a safe level for human beings, the power circuit will be interrupted and current will stop flowing. It must then be reset to restart.

(2) The charge current may be set in the EVSE to a “safe” level. There are usually 3 or more settings. For example the circuit outlet may be rated at 15 amps but it may be safe at a lower current level only. So the standard settings could be 4 amps, 8 amps or 12 amps to ensure safe operation by the user of the EVSE to charge an Electric or Plug-In Hybrid Electric vehicle. This setting is usually determined by the user at the user's discretion making the user responsible for setting the “safe” charge level.

(3) The cord from the EVSE to the wall plug is short with instructions to not use an extension cord because the extension cord may not be protected by a GFI and could result in an electric shock to personnel if wet or if other hazards exist.

(4) The EVSE is used only for Level 1 (120 Volt, 15 amp) at a maximum of 1.4 Kw and Level 2 (205 to 240 volts, from 3.3 kw up to 15 kw). Level 3 or high voltage and power charger stations can only be a permanently installed certified stationary charging station and professionally installed with the aid of the electric utility company. These high power stations also may use a special standard plug established by the manufacturer or Government because of the potential dangers.

### Several Embodiments

In many embodiments of the present application, a Safe Charging System (SCS) and associated methods are described herein.

In many embodiments, a SCS may be implemented on board a EVS that is capable of being plugged into an external electrical power source to recharge the on board battery pack of the EVS. As the external power source may vary in quality and over time (depending on the state of the grid infrastructure where the EVS is located), the SCS may be configured to sample the quality of the electrical power dynamically—e.g., such that the EVS may safely charge the battery pack over time and at times when the quality may be poor and/or may vary.

Many SCS embodiments may sample certain characteristics and/or conditions (e.g. voltage, current, power conditions or the like) of the external power source and may dynamically charge the battery pack according to the functions of such characteristics. In addition, it may be known in advance that external power may be compromise (e.g., brownout, blackouts or the like) and such known power conditions may be a characteristic that may be computed by a function and/or a metric that may be employed by the SCS for dynamic charging of the battery pack.

The charging level of the battery pack may dynamically vary according these functions and/or metrics of the characteristics of the external electrical source. For example, the charging level may go up (e.g., if the external electrical source appears good and/or stable). Alternatively, the charging level may go down (e.g., if the external electrical source appears to be having quality issues and/or unreliable).

Various embodiments may continue charging the battery pack for a desired time period (e.g. 1 to 15 minutes, for merely exemplary purposes). It will be appreciated that this desired time period may be changed during the course of a charging cycle—e.g., possibly in response to different conditions of battery state, quality of external electrical power or other conditions. Additionally, in one embodiment, it may be desirable for the charging “On” period to be longer than the “Off” period—with both periods potentially adjustable (possibly according to certain conditions).

At the end of this desired time period, the system/method may return to measuring the characteristic and continue charging in a same manner. The charging may be stopped according to some desired condition—such as, the user unplugging the EVS, the expiration of a time period (e.g., 1 to 15 hours, for merely exemplary purposes), whether the battery pack has been charged to a given level, or if it known that the external electrical source is going to have particular problems/issues.

FIG. 2 is one embodiment of a SCS system—which may be placed on board an EVS vehicle 200. In one embodiment, SCS system may comprise an intelligent charging unit 202 and a safe charging system (SCS) module 204. It will be appreciated that these two systems may be combined into one unit—or may be configured in multiple units throughout the vehicle—or, even off the vehicle. These units may also comprise one or more processor units that are in operative communication with computer readable storage media. Such media may further comprise computer-readable instructions, such that when read by a processor, may cause the processor to perform one or many possible methods and/or programs as disclosed herein.

In one embodiment (such as shown in FIG. 2), it may be possible for the vehicle 200 to comprise a plug 208 to communicate with outside electrical sources. Plug 208 may be attached to a long cord 210—that, in turn, may attach to a standard wall plug 212. Such wall plug 212 may preferably have a GFI with a reset button as shown. Other wall plug configurations are of course contemplated in the scope of the present application—such as without GFI and/or with or without a reset button. It will also be appreciated that although FIG. 2 depicts vehicle plug 208 as a male plug, it may be possible for the plug to be a female plug at the vehicle. In fact, the wall plug and the vehicle plug may be of any gender desired and the cord may be constructed to work with such arrangement as desired.

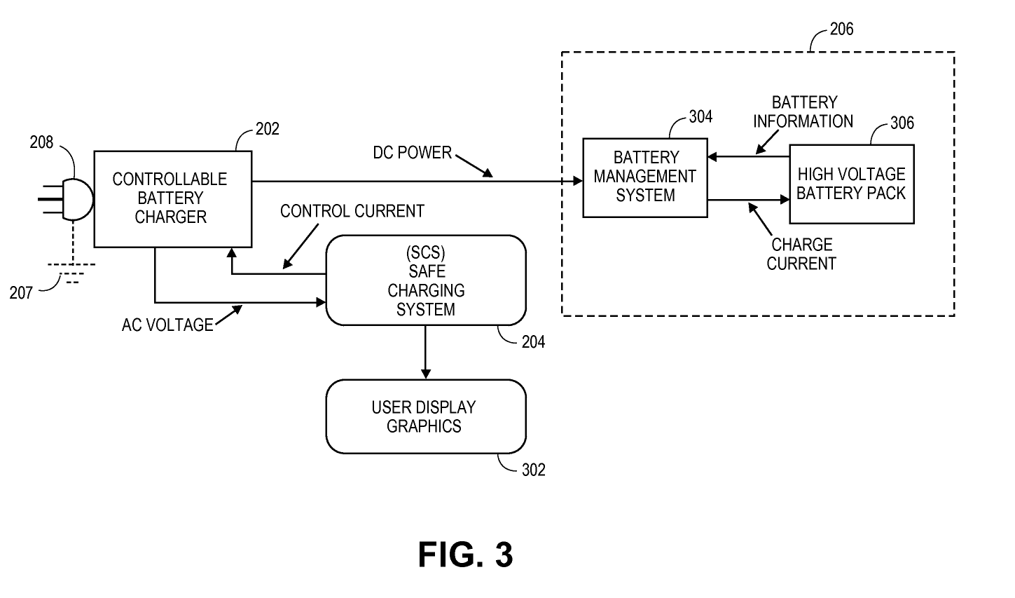

FIG. 3 depicts another embodiment of a SCS system 300. In this embodiment, the SCS system may further comprise a controllable battery charger 202. This charger 202 may be in communications electrically via plug 208—that may be supplying AC power to charger 202. Charger 202 may supply DC power to the battery system 206. Battery system 206 may further comprise a battery management system 304 and a battery pack 306—where battery state information and current charge may be exchanged there between.

Charger 202 may also be in communication with Safe Charging System (SCS) module 204—and, in turn, may be in communication with an optional user display graphics 302. As may be seen, SCS module 204 may receive signals that correlate with characteristics of the AC voltage/energy being received by charger 202. In addition, SCS 204 may optionally be receiving state information/signals from the battery system 206.

From these signals and/or information, SCS 204 may perform computer control methods and/or algorithms that help to provide the EVS with a safe and/or effective charging cycle, when plugged in. Optionally, the user may be provided with system status with display 302—in addition, it may be desirable to provide user with some input commands and/or controls to effect a desired charging cycle.

### Other Embodiments

In other embodiments of the present application, it may be desired to use conventional commercially available GFI outlets which may be commodity items at a low cost in the location and/or country in which the EVS is operating. If available, they may be a part of a 3 wire system with a safety ground wire. Most electrical systems used in the world have a safety ground with or without GFI protection. In locations and/or plugs where there is no effective GFI protection, one embodiment of the SCS system may include effective GFI as a part of the system. For one embodiment, GFI may be provided at plug 208 which may be on board the EVS itself. In another embodiment, a reset button may also be provided at plug 208 deployed on the EVS. In such embodiments, it may be possible to supply a separate ground connection to the EVS to affect such GFI. It may be possible (in some embodiments) for plug 208 to optionally supply a ground connection 207 in places where 3 wire connections are not available and/or possible.

In some embodiments herein, it may be possible to eliminate the need for a separate box or EVSE for Level 1 and Level 2 charging. In addition, many embodiments may use any commercially available 3 wire electric extension cord from the GFI to the vehicle rated to carry a certain current. This may tend to extend the availability to access to the existing electrical infrastructure already installed in houses and buildings. If a 3rd ground wire system is not installed, it may be possible to have a separate ground pathway implemented on the EVS to affect a desired GFI (e.g., ground 207).

As will be discussed further herein, the SCS may be implemented to determine the electric current and power that the circuit can support safely without over heating or causing an external or internal fire. In addition, the SCS may optionally provide the user automatic feedback on a computer screen that shows the safe charging level for a particular circuit and other information.

In some embodiments, the user may then decide to use the existing circuit and extension cord or move to another GFI circuit outlet and extension cord. This may tend to give the user a choice the charge time to fill the batteries will vary to affect a safe charge cycle. In one embodiment, the SCS may estimate the charge time for a full charge and the user may then decide to use the existing circuit and extension cord—or move on to another circuit which may have higher capability and thus shorter charge time to fill the batteries.

In some embodiments, the SCS may no longer require the user to decide a “safe” charging level but it may decide on its own and feed information on the length of time to charge and the available charging level to the user. If the charging level is close to the rated level of the circuit say 15 amps then the user may know that another circuit may not reduce his time of charge unless the user goes into a higher rated circuit for higher current or voltage.

The SCS may also eliminate the need for an EVSE and thus may tend to be lower in cost—with more information to the user to decide on time of charge. It may also tend to determine the integrity of the external wiring so that the user may avoid a future electrical fire. For example, if a house outlet is rated at 15 amps but it can only carry 7 amps safely as determined by the SCS then the user knows that the circuit is degraded and he should not use the circuit for other appliances that are rated for higher than 7 amps. In these embodiments, the SCS may be used as a diagnoses and educational tool by the average user of a PEV.

### One Control Embodiment

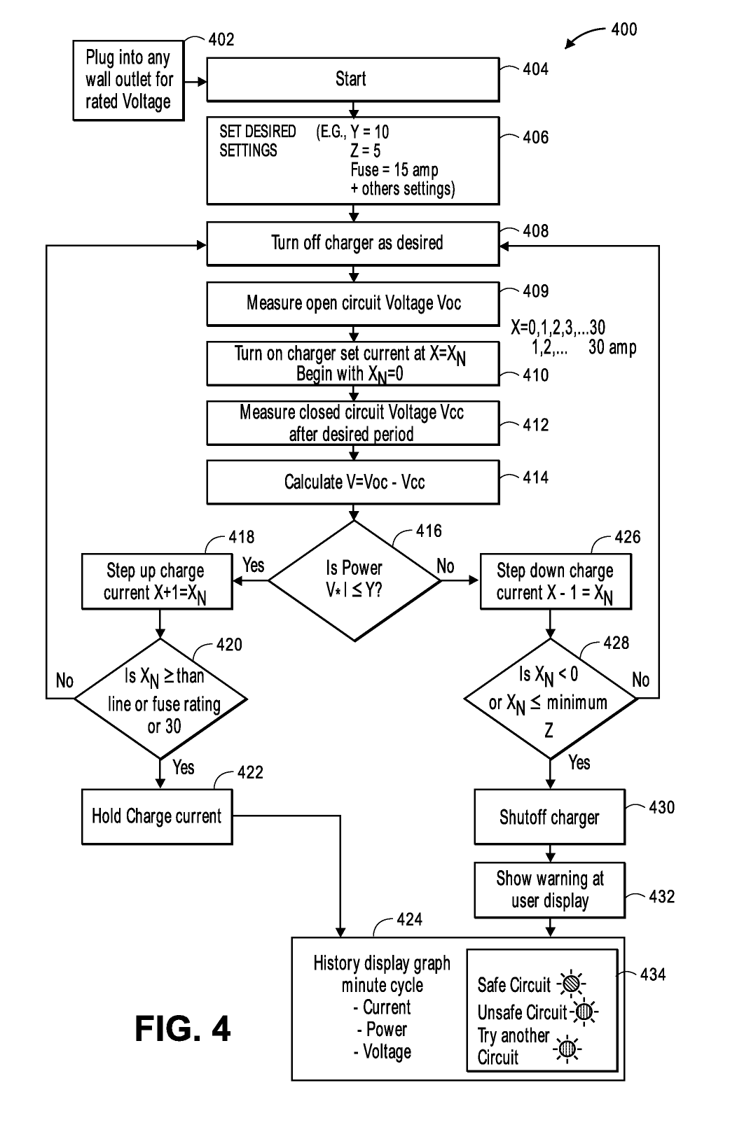

As mentioned, the SCS may be controlled by one or more processors under suitable computer readable instructions that provide the control for effective (semi-) automatic control of the charging cycle. FIG. 4 is merely one embodiment of a method and/or algorithm that may tend to affect an automatic charging cycle—while safely sampling and/or setting the charging level that is being applied to the EVS—e.g., on a substantially real-time basis.

In this embodiment, the vehicle may be mated electrically to whatever wall plug and/or external electrical source that may be available at 402. The system may be set to start at 404—either manually or automatically. At 406, settings may be noted and/or set—either manually or automatically—to possibly include the watt value of the plug/source, any fuse values (if noted).

At 408, the system may turn off the charger for a desired period of time (e.g. 5-10 minutes or any other suitable time period). At 409, the system may measure, sample and/or accept as input the open circuit voltage (V_{OC})—and the charger may set a current value at a starting value and/or level (e.g., the “X” variable—which may range between a first value and a second level, for example, 0 or 1 amps to 30 amps, or any other suitable range). At 410, the system may turn on the charger at an initial value (X₀)—and an adjusted value (X_{N}) at another time, as the system may allow.

At 412, the system may measure, sample and/or accept as input the closed circuit voltage (V_{CC}) after a desired time period (e.g., one minute or any other suitable time period). At 414, the system may calculate the difference in voltages (e.g., V=V_{OC}−V_{CC}).

The system may then test and/or query at 416 whether the power (i.e., V*I) is approximately less than or equal to some value of Y (which is set for merely one example at 10 watts—it should be understood that this value may be set at any value desired).

If it is less than a desired amount of power, then the system may increase the current amount by a given increment (e.g., 1 amp or whatever amount desired) at 418. The system may then go back to 410 and recursively set X until the power is in an acceptable range for the charging cycle.

At 420, the system may query and/or test whether the current value (e.g., X) is greater than the line or fuse rating in the charging circuit or path. If not, then the system may return to 408 to measure the open circuit voltage. If so, then the system may hold the current level at 422—as it may substantially be the greatest current value within a safe range for the charging circuit and/or cycle.

If, however, at 416, the power is greater than a desired value (e.g., Y), then the system may step down the current by a desired decrement (e.g., 1 amp or the like). The system may test and/or query at 428 whether the current is less than 0 or less than or equal to some minimum value, specified as Z. If it is, then the system may shut off the charger at 430. If not, then the system may return to 408 for continued processing.

If the system shuts down the charging, then the user may be alerted at the optional display at 432 and at 424. An exemplary user interface is depicted at 434.

### Another Embodiment

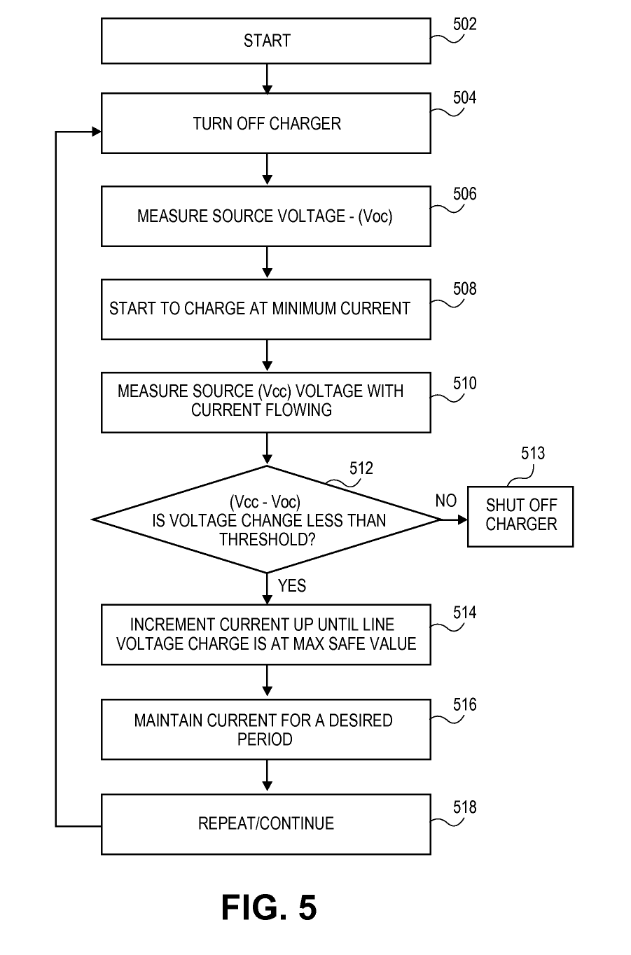

FIG. 5 is yet another embodiment of a system and/or method as made in accordance with the principles of the present application.

The system may start at 502—e.g., when the charger is plugged into an external electrical source. At 504, the system may start with the charger turned off. The source voltage may then be measured at 506.

The system may start to charge at a minimum current at 508—wherein this current may be dynamically changed at shown herein. V_{CC} may then be measured at 510 and the voltage change (V_{CC}−V_{OC}) may be threshold tested at 512—for safety and optimum selection.

If the current is not below such a threshold, then the charger may be turned off at 513. Otherwise, the system may increment the current at 514. This may be done until the current is at a desired maximum safe value.

At 516, this current may be maintained by the system for some desired period of time. At 518, the system may return back to 504 in order to repeat the process.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A system for safe charging an EVS, said EVS connecting to an external electrical power line to charge a battery pack, the system comprising:
a controllable battery charger, said controllable battery charger configured to be in electrical communication with an external electrical power line;
a safe charging system (SCS) module, the safe charging system module in electrical communication with the controllable battery charger, the SCS module receiving signals correlating to the electrical power from the external electrical power line and outputting control signals to the controllable battery charger; and
wherein further the SCS module outputs control signals to the controllable battery charger to dynamically adjust the charging of the battery according to a function of measured external electrical power characteristics.

2. The system of claim 1 wherein the EVS further comprises a plug, the plug in electrical communications with the controllable battery charger, and the plug being capable of being plugged in to the external power line with an extension cord.

3. The system of claim 2 wherein the plug comprises a three prong plug and wherein one of the prongs comprises a ground connection.

4. The system of claim 2 wherein the plug comprises an optional ground connection.

5. The system of claim 1 wherein the controllable battery charger dynamically set the charging level of DC power sent to the battery pack of the EVS, according to control signals sent from the SCS module.

6. The system of claim 5 wherein the function of measured external electrical power characteristics substantially comprises the measured voltage difference between V_{CC} and V_{OC}.

7. The system of claim 6 wherein the controllable battery charger dynamically increments the charging current to the battery pack up to a desired safe value, the desired safe value based upon the measured voltage difference.

8. The system of claim 7 wherein the controllable battery charge holds charging current for a desired period of time and, at the expiration of the desired period of time, shuts off the charging to the battery pack.

9. The system of claim 8 wherein, after the expiration of the desired period of time, the SCS module resumes monitoring the external electrical power characteristics to provide a new desired period of safe charging for the battery pack.

10. A method for the safe charging of an EVS, the EVS capable of electrically communicating with an external electrical power source and providing safe charging for a battery pack, the method comprising:
(i) plugging in the EVS to an external electrical source;
(ii) measuring a first characteristic related to the external electrical source;
(iii) charging the battery pack at a first desired current level;
(iv) dynamically changing the charging current level according to a metric depending upon the first characteristic;
(v) charging of the battery pack for a desired time period;
(vi) upon expiration of the desired time period, returning to (ii) for continue processing; and
(vi) stopping the charging the battery pack according to the desired conditions.

11. The method of claim 10 wherein the first characteristic is one of a group, said group comprising: voltage conditions, current conditions, power conditions, known power conditions.

12. The method of claim 10 wherein the first characteristic is source voltage (V_{OC}).

13. The method of claim 12 wherein the metric is the difference between V_{OC} and the voltage when the charging current is flowing (V_{CC}).

14. The method of claim 10 wherein the desired time period is approximately in the range from one minute to 15 minutes.

15. The method of claim 10 wherein the desired conditions for stopping charging comprises one of a group, said group comprising: the user unplugging the EVS, the expiration of a time period, whether the battery pack has been charged to a given level, and if it known that the external electrical source is going to have particular problems/issues.
